(19) United States
(12) Patent Application Publication
(10) Pub. No.: US 2004/0196675 A1
(43) Pub. Date: Oct. 7, 2004

(54) Self-powered direct current mitigation circuit for transformers

(76) Inventors: David Cope, Medfield, MA (US); David Fischer, Waltham, MA (US)

Correspondence Address: HAYES SOLOWAY P.C., 175 Canal Street, 4th, Manchester, NH, 03101-2335, US

(21) Appl. No.: 10/634,434

(22) Filed: Aug. 5, 2003

Related U.S. Application Data
(60) Provisional application No. 60/401,187, filed on Aug. 5, 2002.

(51) Int. Cl. H02J 1/02

(52) U.S. Cl. 363/39

(57) ABSTRACT

A DC mitigation circuit for mitigating the effects of DC in power systems, and a method for doing the same, are provided. The DC mitigation circuit comprises a control circuit for evaluating the amount of DC or harmonic currents resulting from the DC in a transmission line. Switches provide a current to a winding of a transformer, and are controlled by the control circuit. The current provided to the winding generates a magnetic flux that offsets a flux created by DC or harmonic currents resulting from the DC induced by geomagnetically-caused ground-induced currents in the transmission line.

### CROSS-REFERENCE TO RELATED APPLICATION

This application claims priority to provisional application No. 60/401,187 filed on Aug. 5, 2002, which is incorporated herein by reference in its entirety.

### STATEMENT REGARDING FEDERALLY SPONSORED RESEARCH OR DEVELOPMENT

This invention was made with Government support under contract number DASG60-01-C-0017 awarded by the Department of Defense. The Government has certain rights in the invention.

### FIELD OF THE INVENTION

The present invention relates generally to electrical power systems, and relates particularly to a circuit for mitigating the effect of direct current (DC) or harmonic currents resulting from the DC in transformers.

### BACKGROUND OF THE INVENTION

Society reliance on electricity for meeting essential needs has steadily increased for many years. This unique energy service requires coordination of electrical supply, demand, and delivery—all occurring at the speed of light. Disturbances caused by solar activity can disrupt complex power systems that provide electricity. When the Earth's magnetic field captures ionized particles carried by solar wind, geomagnetically-caused ground-induced currents (GIC) can flow through the power system, entering and exiting the many grounding points on a transmission network. As is known by those of ordinary skill in the art, GICs are produced when shocks resulting from sudden and severe magnetic storms subject the Earth to fluctuations in its normal magnetic field. These fluctuations induce electric fields in the Earth, resulting in potential differences in voltage between the grounding points of the transmission network, thereby causing GICs to flow through transformers, power system lines, and the grounding points. Only a few amps are needed to disrupt transformer operation, however, over 200 amps have been measured in the grounding points of transformers in affected areas. Unlike threats due to ordinary weather, space weather, which is dependent on the environmental conditions on the Sun and in solar wind, magnetosphere, and the ionosphere, can influence the performance and reliability of space-borne and ground-based technological systems, can readily create large-scale technological problems since the footprint of an associated storm can extend across a continent and across the globe. As a result, simultaneous widespread stress occurs across power systems to the point where widespread failures and even regional blackouts may occur. Systems in the upper latitudes of the Northern and Southern Hemispheres are at increased risk because Auroral activity and its effects center on the magnetic poles. North America is particularly exposed to these storm events because the Earth's magnetic north pole tilts toward this region, thereby bringing the storms closer to the dense critical power grid infrastructure across the continent.

Prior to March 1989, geomagnetic disturbances were thought to only cause nuisance level problems for power systems. The events that unfolded at Hydro Quebec in the early morning hours of Mar. 13, 1989, illustrate the challenges that lie ahead in managing geomagnetic disturbances. At 2:42 am, all operations were normal; at that time, a large impulse in the Earth's magnetic field erupted along the US/Canada border. Voltage on the network began to decrease as the storm developed. As a result, automatic-compensating devices rapidly turned themselves “ON” to compensate for the decrease in voltage. However, the automatic devices were themselves vulnerable to the storm and failed within less than a minute. In fact, within ninety (90) seconds all of Quebec lost power.

The rest of the North American system also reeled from this storm. Over the course of the next 24 hours, five more large disturbances propagated across the continent, the only difference being that they extended much further south and very nearly toppled power systems from the Midwest to the Mid-Atlantic Regions of the US. The National Energy Research Council, in their post analysis, attributed over two hundred (200) significant anomalies across the continent to this one storm. Over the next five (5) years, smaller storms demonstrated time and again for the power industry that significant impacts could be triggered at even lower storm levels.

For perspective, the limited climatologic data available suggests that storms of even larger intensity and with a larger planetary footprint are possible than the one that occurred in March 1989. Also, the power industry realizes that its vulnerability continues to incrementally grow over time. As a result, the challenges of this solar cycle may be even greater than those posed over 10 years ago. Current methods are being developed and adopted to better manage risk associated with space weather.

One method that has been implemented to control the effect of DC generated by GICs in transformers, is using a DC blocker on a primary winding side of the transformer. The DC blocker includes large capacitors that interrupt current by creating an open circuit on a DC basis while appearing as a closed circuit on a power frequency basis. Unfortunately, this solution is complicated and expensive to implement and fraught with safety considerations.

### BRIEF SUMMARY OF THE INVENTION

The embodiments of the present invention relates to a DC mitigation circuit for mitigating the effects of DC or harmonic currents from the DC, in a power system.

Briefly described, in architecture, one embodiment of the system, among others, can be implemented as follows. The DC mitigation circuit contains a control circuit for evaluating an amount of DC and/or harmonic AC in a transmission line and switches for providing a current into a winding of a transformer, wherein the switches are controlled by the control circuit. In addition, the current provided to the winding generates a magnetic flux that offsets a flux created by the DC in the transmission line.

The present invention can also be viewed as providing methods of performing DC mitigation. In this regard, one embodiment of such a method, among others, can be broadly summarized by the following steps: evaluating an amount of DC and/or harmonic AC in a transmission line; and providing a current into a winding of a transformer based on the evaluated amount of DC and/or harmonic AC, the current generating a magnetic flux that offsets a flux created by the DC in the transmission line.

The above objects, features and advantages of the present invention will be apparent in the following detailed description thereof when read in conjunction with the appended drawings wherein the same reference numerals denote the same or similar parts throughout the several views.

### BRIEF DESCRIPTION OF THE DRAWINGS

FIG. 1 is a schematic diagram illustrating use of a DC mitigation circuit, in accordance with a first exemplary embodiment of the invention.

FIG. 2 is a schematic diagram illustrating a power transmission system including the DC mitigation circuit of FIG. 1.

FIG. 3 is a schematic diagram illustrating the DC control circuit of FIG. 1 having each phase of a three phase signal receiving a different type of compensation control.

FIG. 4 is a block diagram describing operation of the DC mitigation control circuit of FIG. 1 when the circuit is performing primary compensation.

FIG. 5 is a block diagram describing operation of the DC mitigation control circuit of FIG. 1 when the circuit is performing secondary compensation.

FIG. 6 is a block diagram illustrating operation of the DC mitigation control circuit of FIG. 1 when the circuit is performing core compensation FIG. 7 is a flow chart describing operation of the DC mitigation circuit of FIG. 1.

FIG. 8 is a schematic diagram illustrating a test circuit used to evaluate efficiency of the DC mitigation circuit of FIG. 1.

FIG. 9 is a graph comparing harmonic distortion for the simulated power system of FIG. 8 according to system test data.

### DETAILED DESCRIPTION

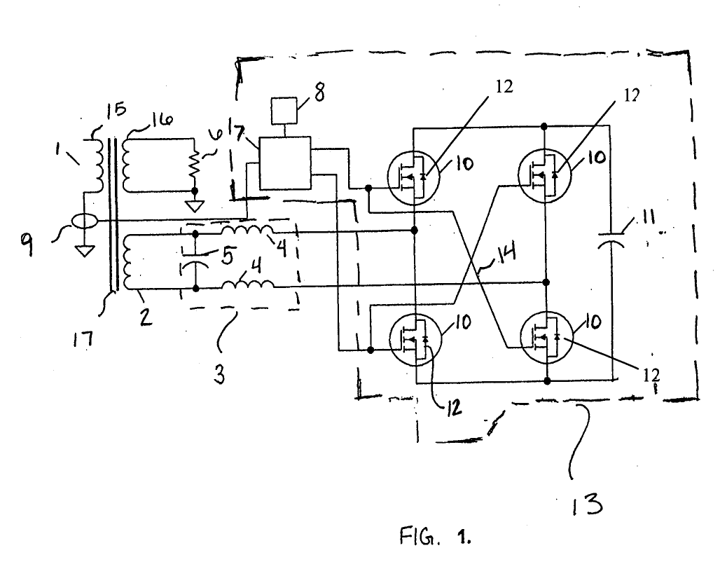

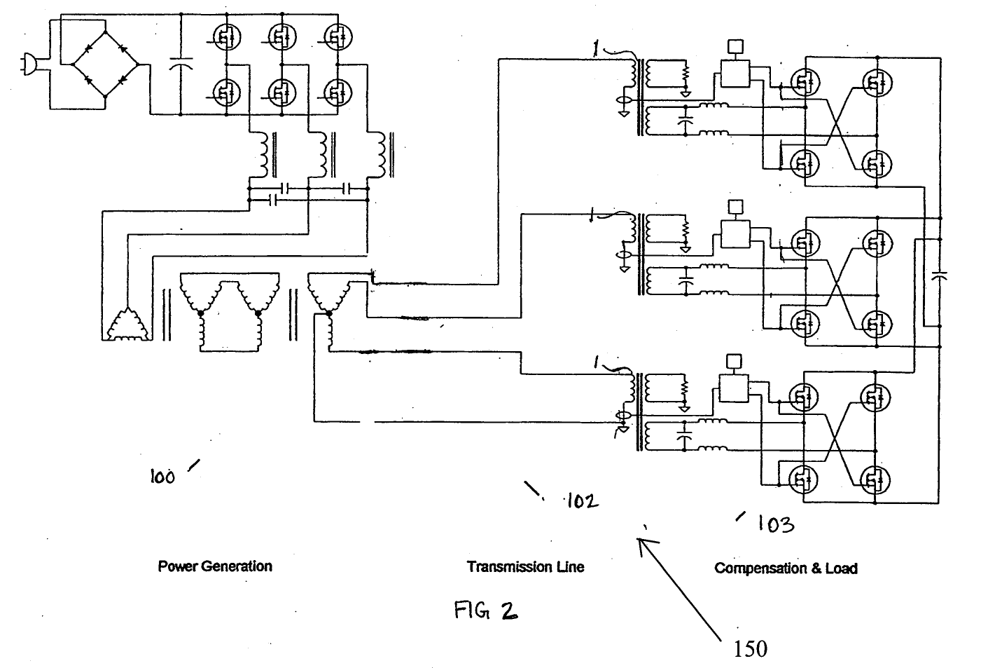

FIG. 1 is a schematic diagram illustrating use of a DC mitigation circuit in accordance with the first exemplary embodiment of the invention. FIG. 1 illustrates a single phase transformer connected to an output filter 3, which is connected to a DC mitigation circuit 13. The single phase transformer 1 has a primary winding 15, a secondary winding 16 connected to a load 6, a tertiary winding 2 connected to the output filter 3, and a core 17. The output filter 3 contains a capacitor 5 and inductors 4 connected to the DC mitigation circuit 13. The DC mitigation circuit 13 contains an H-bridge rectifier 14 formed from four n channel metal-oxide semiconductor field-effect transistor (MOSFET) switches 10, (although p channel MOSFET switches may be substituted). The inductors 4 in the output filter 3 are each connected between a source and a drain of one of a pair of MOSFET switches 10 in the H-bridge rectifier 14. Each MOSFET switch 10 has an anti-parallel diode 12, i.e., a diode connected across an electrical element such that current flow through the diode is opposite that through the element, connected across its source and drain. Power is supplied to the source of two MOSFET switches 10 and to the drain of the other two MOSFET switches 10 via capacitor 11.

Control of the MOSFET switches 10 is provided a DC mitigation control circuit 7, which is connected to the gates of each MOSFET switch 10. The DC mitigation control circuit 7 is connected to the primary winding 15 of the transformer 1 via current sensor 9. Further, the DC mitigation control circuit 7 is connected to its own controller power supply 8. However, controller power supply 8 does not provide power to the MOSFET switches 10.

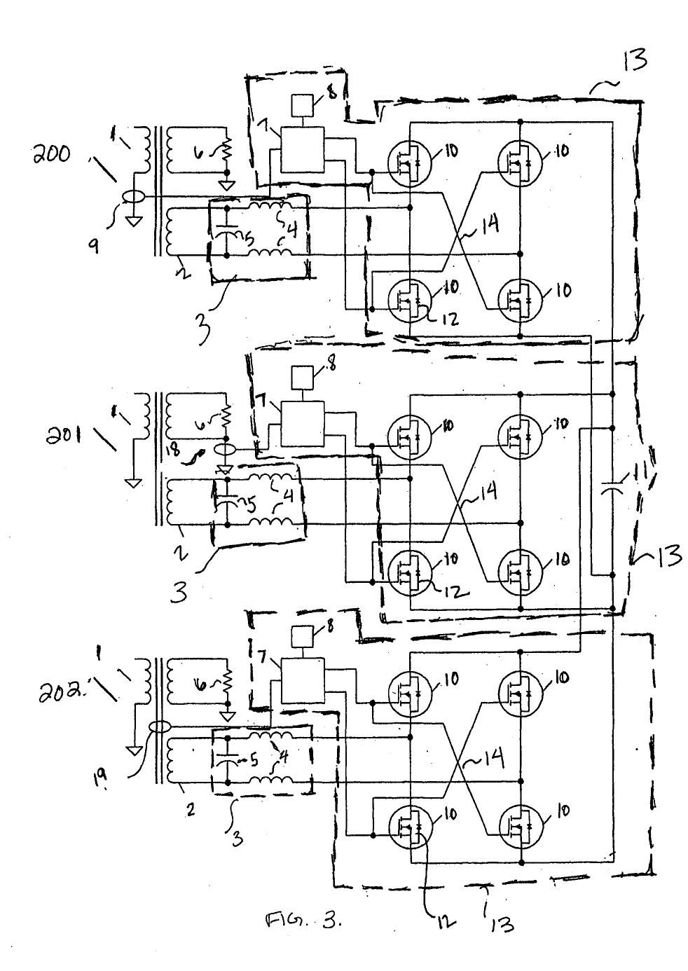

FIG. 2 is a schematic diagram illustrating a power transmission system 150 including the DC mitigation circuit 13 of FIG. 1. Specifically, FIG. 2 illustrates the transformer 1, output filter 3 and DC mitigation circuit 13 of FIG. 1 may be integrated into the power system 150. The power system 150 contains a power generation apparatus 100 for generating a three phase AC current in a transmission line 102, a DC mitigation circuit 13 for each of the three phases, and a load 6 of FIG. 1, collectively 103. Various power generation apparatus are well-known in the art and the instant invention may be used with any such power generation apparatus. In addition, it should be noted that the present DC mitigation circuit may be utilized within a different power system. Although the DC mitigation circuits 13 of the present invention are provided on the load side of the power system 150, alternatively the DC mitigation circuit 13 can be provided on the power generation side of the power system 150. It should be noted that the DC mitigation control circuit 7 may be coupled to the transformer 1 in different ways.

FIG. 3 is a schematic diagram illustrating the DC mitigation control circuit 7 of FIG. 1 having each phase of a three phase signal receiving a different type of compensation control only for exemplary reasons. As is shown by FIG. 3, the DC mitigation control circuit 7 is coupled to a transformer 1 in three different configurations. Configuration 200 shows the DC mitigation control circuit 7 being coupled to the transformer 1 so as to implement a primary compensation control (i.e., compensation of DC current in the primary winding 15 of the transformer 1). Configuration 201 shows DC mitigation circuit 13 being coupled to the transformer 1 so as to implement DC compensation through or by measurement of harmonics in the primary winding 15 or secondary winding 16 of the transformer 1. Configuration 202 shows the DC mitigation circuit 13 being coupled to the transformer 1 so as to implement core compensation control (i.e., compensation of DC flux in the core 17). Although each configuration described in FIG. 3 mitigates DC and/or harmonic AC in different areas of the transformer 1, in practice a single circuit would perform primary, secondary and/or core compensation.

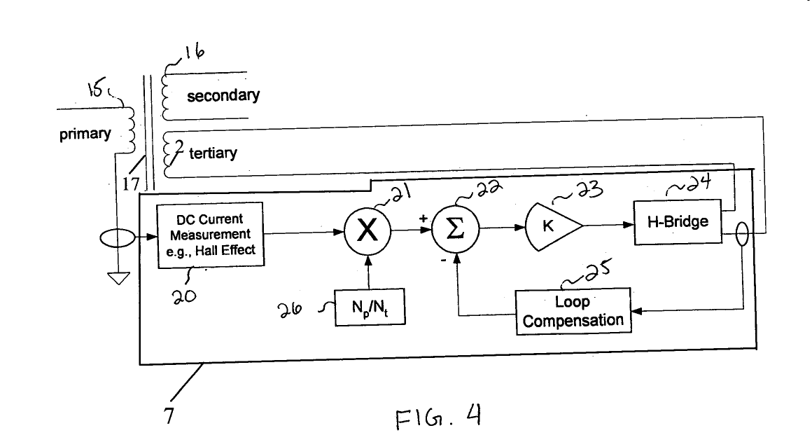

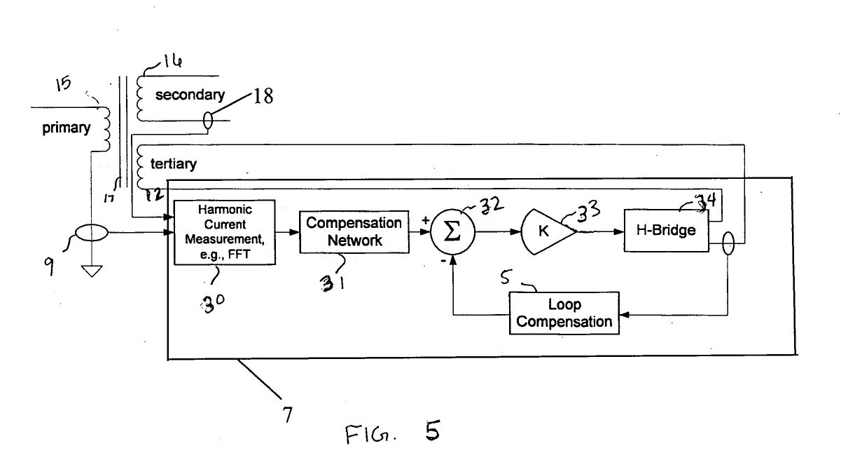

FIG. 4 is a block diagram describing operation of the DC mitigation control circuit 13 of FIG. 1, when the circuit 13 is performing primary compensation.

As is shown in FIG. 4, in order to perform primary compensation, the DC mitigation control circuit 7 is connected to the primary winding 15 of the transformer 1 at current sensor 9. The DC mitigation control circuit 7 first measures the amount of DC current in the primary winding, e.g., via the Hall effect, as shown in block 20 of FIG. 4. Then, as shown by the multiplier block 21 and the ratio block 26, the DC mitigation control circuit 7 multiplies the measured DC current by the ratio of the number of turns of the primary winding 15 to the number of turns of the tertiary winding 2. The output of the multiplier block 21 represents the amount of DC current that is required to be generated by the tertiary winding 2 to offset the flux created by the DC current in the primary winding 15. The output of the multiplier block 21 is inputted to the summing block 22. The summing block 22 adds the output of the multiplier block (a positive value) to the output of the loop compensation block 26, (i.e., the value of the last DC current outputted by the H-bridge 24). The loop compensation block 25 inputs a negative value into summing block 22. If summing the input from the multiplier block 21 and the input from the loop compensation block 25 results in a zero value, then the DC mitigation circuit 13 is performing compensation correctly, and the H-bridge 24 maintains its current output. However, if the result output from the summing block 22 is not zero, then a signal indicating the amount of current necessary to offset the flux created by DC current in the primary winding 15 is amplified in block 23 and outputted to the H-bridge 24.

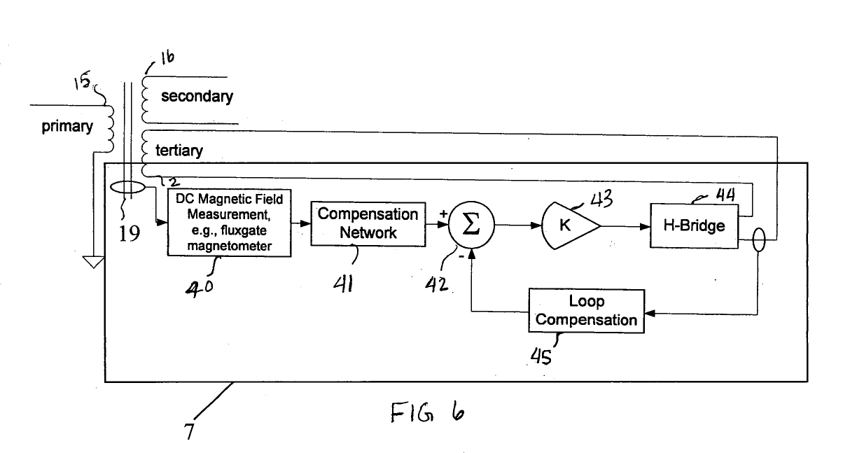

FIG. 5 is a block diagram describing operation of the DC mitigation control circuit 7 of FIG. 1 when the circuit 7 is performing primary or secondary compensation.

As is shown in FIG. 5, in order to perform secondary compensation, the control circuit 7 is connected to the secondary winding 16 of transformer 201 at connection point 18 or alternatively to the primary winding 15 at connection point 9. As shown in block 30, the DC mitigation control circuit 7 of the instant invention first performs a harmonic current measurement using, for example, a Fast Fourier Transform on the input from either the secondary winding 16 or the primary winding 15. The control circuit 7 then outputs the magnitude and phase data generated in block 30 to a compensation network block 31. The compensation network block 31 determines the magnitude and phase the tertiary winding 12 is required to output to offset that created by harmonic AC current in either the primary winding 15 or the secondary winding 16. The output of the compensation network block 31 (positive values) is then inputted into the summing block 32 along with the output of a loop compensation block 35 (i.e., the magnitude and phase of the last current output by the H-bridge 34). Like primary compensation, the loop compensation block 35 outputs a negative value. Also like primary compensation, if the output of summing block 32 is zero, then the H-bridge 34 maintains its current output. However, if the summing block 32 outputs a non-zero value, then a signal indicating the current necessary to offset the harmonic AC is amplified in block 33 and then outputted to H-bridge 34.

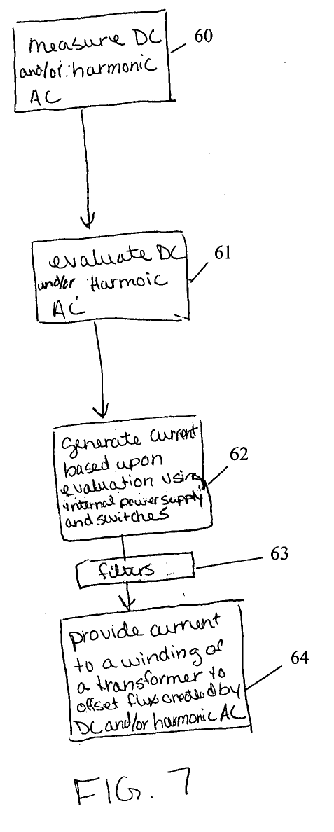

As is shown in FIG. 6, in order to perform core compensation, the DC mitigation control circuit 7 is connected to the core 17 at connection point 19. The DC mitigation control circuit 7 first measures the magnetic field created by DC in the transformer in block 40 using, for example, a fluxgate magnetometer. The output of block 40 is then inputted into a compensation network block 41, which filters any AC component using, for example, a RC Filter. The output of the compensation network block 41 is then inputted into a summing block 42 along with the output of a loop compensation block 45 (i.e., the amount of DC output from an H-bridge 44). Like primary and secondary compensation, if the output of summing block 42 is zero, then H-bridge 44 maintains its current output. However, if the summing block 42 outputs a non-zero value, then a signal indicating the current necessary to offset the DC magnetic flux is amplified in block 43 and then outputted to the H-bridge 44.

Operation of the DC mitigation circuit 13 of FIG. 1 described below with reference to the flow chart of FIG. 7, and the schematic diagrams of FIG. 1 and FIG. 2. Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

Generally, the DC mitigation circuit 13 measures the amount of DC or harmonic currents resulting from the DC (block 60). The circuit 13 then evaluates the DC or harmonic currents resulting from the DC using the procedures described above (block 61). The circuit 13 then generates a current based upon the evaluation of the DC or harmonic currents resulting from the DC using an internal power supply and switches (block 62), filters the output of the switches (block 63) and provides current to a winding of the transformer 1 to offset flux created by the DC or harmonic currents resulting from the DC (block 64).

As described in the description of FIG. 2, the power generation circuit 100 generates an AC current that is transmitted through transmission line 102 to transformer 1. The primary winding 15, the secondary winding 16, and the core 17 of transformer 1 are connected to DC mitigation control circuit 7. Based upon the primary current, secondary current, and core flux characteristics, as shown in FIG. 1, the DC mitigation control circuit 7 outputs switching information to MOSFET switches 10. The MOSFET switches 10 are powered by a capacitor 11. The anti-parallel diodes 12 carry current an opposite direction from MOSFET switches 10 to allow the capacitor 11 to be charged by the other phases. Under phase control, each of the MOSFET switches 10 in the H-bridge force current from capacitor 11 to flow in the tertiary winding 2 during a portion of the frequency cycle, creating a magneto-motive force (mmf) that cancels the mmf caused by the DC current in the transformer 1. Finally, the output of the MOSFET switches 10 may be filtered by capacitor 5 and inductors 4.

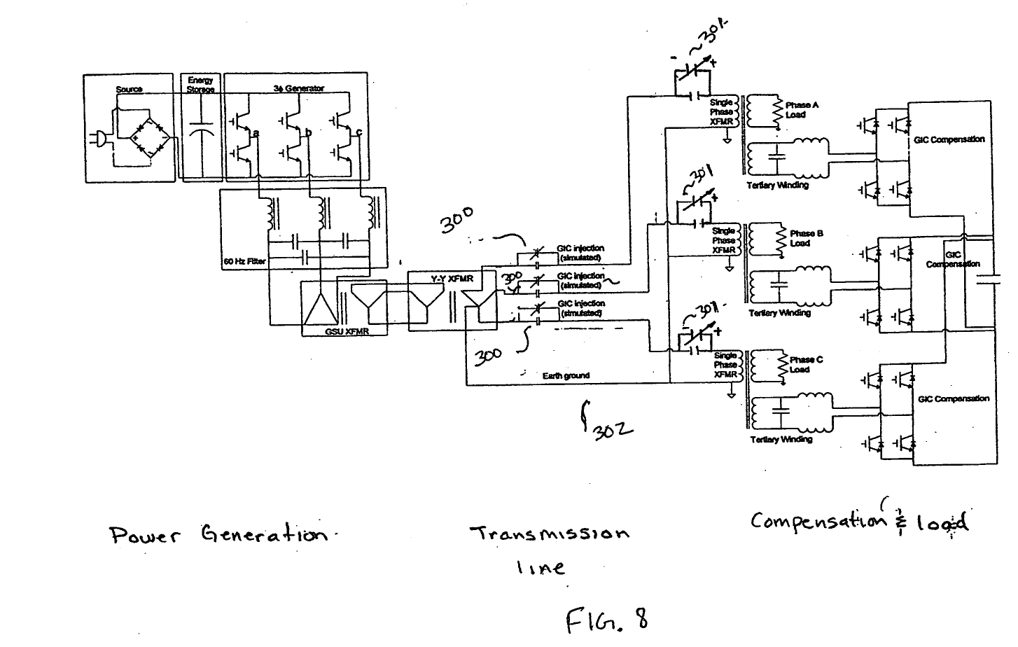

The DC current mitigation circuit 13 of the present invention may be tested using the simulated power system shown in FIG. 8. Either apparatus 300 or 301 was used to simulate injection of GICs into the transmission line 302 to determine the level of disruption GICs cause to a power system. Both apparatus 300 and 301 comprise a variable power source 304 and a capacitor 306 in parallel with transmission line 302. DC or harmonic currents resulting from the DC compensation was then provided by the present invention on a phase-by-phase basis. When the DC mitigation circuit of the instant invention was not employed, power quality degraded substantially. But, when the DC mitigation circuit was connected to the transformer, almost complete restoration of the baseline power quality was demonstrated.

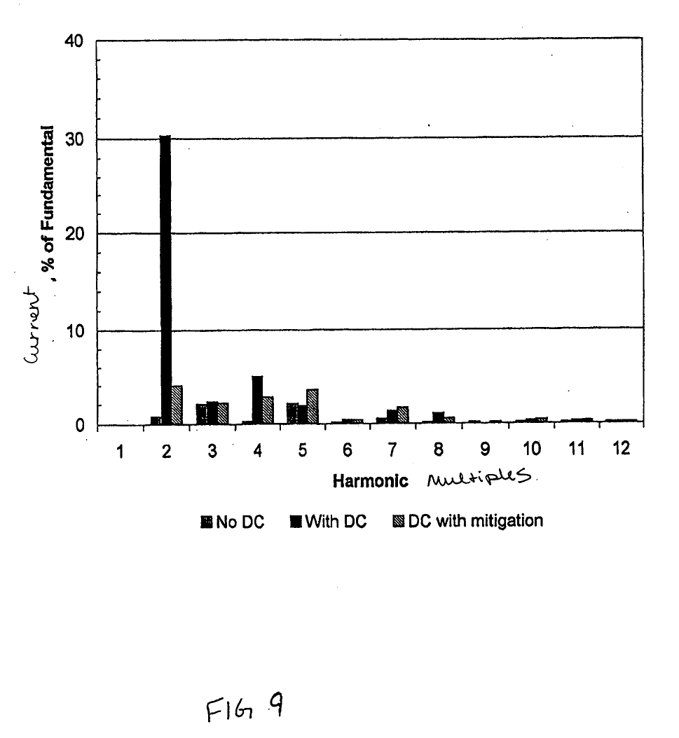

FIG. 9 shows the voltage harmonics generated during each of three tested conditions on the simulated power system. These conditions were: no DC injected into the transmission line, simulated DC GIC injection on the transmission lines without using a DC mitigation circuit, and simulated DC GIC injection using the DC mitigation circuit of the instant invention. Note that in an actual power system, the baseline case (No DC) would have fewer harmonics present than in the simulated power system.

During the simulated DC GIC injection, current harmonics up to 30% of the fundamental were observed. The instant DC mitigation circuit reduced the maximum harmonic to less than 4% of the fundamental. (The baseline maximum harmonic was less than 2% of the fundamental as measured). These test results demonstrate the effectiveness of the DC mitigation circuit of the instant invention.

Testing has further indicated that GIC effects on three-phase transformers are substantially suppressed as compared to three single-phase transformers, i.e., three-phase transformers inherently are better able to reject the common-mode flux perturbations created by common mode GICs. Thus, when inserted into the circuit, three-phase transformers will not show the degree of power quality degradation described above. However, to the extent that the three phases of the transformer carry different GICs, the GIC-type effects (transformer saturation and harmonic generation) will be evident. For example, if GIC is introduced predominantly into one or two phases of a three-phase transformer, then substantial power delivery degradation will occur. Only when equal GICs are introduced in each phase of the transformer will their effects be reduced.

These phenomena may be more important for some types of GIC than for others, depending on the physical source of the current. When GICs are higher, even less sensitive transformer types can be substantially affected. In addition, with higher currents, the effects of any small differences in impedance of electrical connections will be increased, even on three-phase transformers. Thus, the invention involves a compensation technique that is completely general in nature, and is applicable to all transformer types.

As one skilled in the art will recognize, MOSFET switches 10 may be replaced by controllable conductive devices, including, but not limited to insulated gate bipolar transistors (IGBTs). Further, if the diode that forms the anti-parallel structure is not integral to the controllable conductive device, an external diode may be added without departing from the present invention.

One skilled in the art will also appreciate the low cost characteristics for supplying power to the compensation circuit without a dedicated power supply will be of great economic benefit, encouraging widespread implementation of the present invention. Furthermore, the invention has broad applicability, to different transformer types (e.g., three phase, single phase, RF, etc.). In addition, the invention does not interfere with a safety grounding system of the transformer and allows for the automatic compensation of transformer saturation without a separate power supply, thereby reducing cost and complexity of compensation.

It should be emphasized that the above-described embodiments of the present invention are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A DC mitigation circuit, comprising:
a control circuit for evaluating an amount of DC or harmonic current resulting from the DC in a transmission line; and
switches for providing a current into a winding of a transformer, said switches being controlled by said control circuit,
wherein said current provided to said winding generates a magnetic flux that offsets a flux created by said DC or harmonic current resulting from the DC in said transmission line.

2. The DC mitigation circuit of claim 1, wherein said switches are metal-oxide semiconductor field-effect transistors (MOSFETs).

3. The DC mitigation circuit of claim 1, wherein said DC mitigation circuit is connected to an output filter for filtering an output of said switches.

4. The DC mitigation circuit of claim 1, wherein said control circuit is connected to a primary winding of said transformer.

5. The DC mitigation circuit of claim 1, wherein said control circuit is connected to a secondary winding of said transformer.

6. The DC mitigation circuit of claim 1, wherein said control circuit is connected to a core of said transformer.

7. The DC mitigation circuit of claim 1, wherein said switches are connected to a tertiary winding of said transformer.

8. The DC mitigation circuit of claim 1, further comprising a capacitor for powering said switches.

9. The DC mitigation circuit of claim 8, further comprising diodes connected across said switches so as to charge said capacitor during a frequency cycle.

10. The DC mitigation circuit of claim 9, wherein said switches are MOSFETs and said diodes are connected across a source and drain of said MOSFET switches so as to carry current in an opposite direction from said MOSFET switches.

11. The DC mitigation circuit of claim 10, wherein said capacitor discharges during said frequency cycle so as to power said MOSFET switches.

12. The DC mitigation circuit of claim 1, wherein said switches are integrated gate bipolar transistors (IGBTs).

13. A method of performing DC mitigation, comprising the steps of:
evaluating an amount of DC or harmonic current resulting from the DC in a transmission line; and
providing a current into a winding of a transformer based on said evaluated amount of DC or harmonic currents resulting from the DC, said current generating a magnetic flux that offsets a flux created by said DC or harmonic currents resulting from the DC in said transmission line.

14. The method of claim 13, wherein said current supplied to said transformer winding is provided by an internal power supply.

15. The method of claim 14, wherein switches are used to control said current that is outputted from said power supply to said transformer winding.

16. The method of claim 15, further comprising the step of filtering said current output from said switches.

17. The method of claim 13, wherein said switches are metal-oxide semiconductor field-effect transistors (MOSFETs).

18. The method of claim 13, wherein said switches are integrated gate bipolar transistors (IGBTs).

19. A DC mitigation circuit, comprising:
means for evaluating an amount of DC or harmonic current resulting from the DC in a transmission line; and
means for providing a current into a winding of a transformer, said means for providing a current into said winding being controlled by said means for evaluating,
wherein said current provided to said winding generates a magnetic flux that offsets a flux created by said DC or harmonic current resulting from the DC in said transmission line.
